(19) United States
(12) Patent Application Publication
(10) Pub. No.: US 2014/0297090 A1
(43) Pub. Date: Oct. 2, 2014

(54) Autonomous Mobile Method and Autonomous Mobile Device

(71) Applicant: Ryoko Ichinose, Tokyo (JP)

(72) Inventor: Ryoko Ichinose, Tokyo (JP)

(73) Assignee: Hitachi, Ltd., Chiyoda-ku, Tokyo (JP)

(21) Appl. No.: 14/355,075

(22) PCT Filed: Nov. 11, 2011
(86) PCT No.: PCT/JP2011/076056

§ 371 Date: Apr. 29, 2014

(51) Int. Cl. G05D 1/02

(52) U.S. Cl. CPC G05D 1/0274
USPC 701/23

(57) ABSTRACT

An object is to support expansion of information used for travel of an antonomous mobile device.

An autonomous mobile device (1) calculates a localization precision on the basis of sensor data collected during travel through a sensor (102), and updates the localization precision stored in a storage unit (101). Also, the autonomous mobile device calculates the localization precision according to data such as an image transmitted from a general registrant through a portable device, and updates the localization precision. Further, a travel path of the autonomous mobile device (1) is divided for each of areas, the localization precision is also managed for each of the areas, and the autonomous mobile device (1) is controlled by a manual control or a remote control in an area where the localization precision is low.

### TECHNICAL FIELD

The present invention relates to a technique of an autonomous mobile method an autonomous mobile device for autonomous movement on the basis of acquired sensor data and map data.

### BACKGROUND ART

When an autonomous mobile device moves on streets or in buildings, the autonomous mobile device creates a route to a destination through roads and passages, and moves while determining a direction of movement by checking one's own present invention (self-location) against the route. As a method of localizing the self-location, there have been generally known a method of acquiring lat/long by a GPS (global positioning system), and a method of creating map data putting given marks in advance, detecting surrounding marks by a sensor such as laser while moving, and localizing the present invention by checking the detected marks against the map data. When the GPS is used as the sensor, the GPS that can easily acquire the lat/long, the GPS that can easily acquire the lat/long is a method effective for localization of a self-location outdoor. However, this method cannot be used indoor. Also, because a precision of the GPS is largely degraded in the vicinity of the buildings or the street trees even outdoor, a method combined with another localization method is developed for the purpose of obtaining a stable position precision.

Patent Literature 1 discloses a robot management system, a robot management terminal, a robot management method, and a program, which store the map data, and check the stored map data against sensor data obtained by measuring surrounding environmental shapes to localize the self-position.

Also, Patent Literature 2 discloses a positioning combination determination system that combines a plurality of positioning means together to localize the self-position.

Further, Patent Literature 3 discloses an autonomous mobile system and an autonomous mobile device, which obtain an error in localization at respective points through which the autonomous mobile device passes, and if the error is large, notifies a manager of this fact, and urges the manager to update the map.

### CITATION LIST

### Patent Literature

Patent Literature 1: Japanese Unexamined Patent Application Publication No. 2010-277548

Patent Literature 2: Japanese Unexamined Patent Application Publication No. 2011-64523

Patent Literature 3: Japanese Unexamined Patent Application Publication No. 2011-65308

### SUMMARY OF THE INVENTION

### Technical Problem

Each of the techniques disclosed in Patent Literature 1 and Patent Literature 2 has the surrounding environmental shapes as the map data, and checks the map data against the sensor data to enable localization with high precision at a certain place having a characteristic surrounding environmental shape. However, those techniques are based on the assumption that the surrounding environmental shape data within an accurate movement environment is created in advance. Therefore, in the techniques disclosed in Patent Literature 1 and Patent Literature 2, the autonomous mobile device that travels through towns must move and travel over an overall area of a large movement area in advance, and create the map data, to thereby require a considerable work. Also, the technique disclosed in Patent Literature 3 can notify the manager of a place larger in the error of the localization, but that the manager updates the map makes a load on the manager large. That the load on the manager is large leads to such a problem that the costs are increased.

On the other hand, there is conceivable a system of localizing the self-position (hereinafter called “localization system ”) which can travel without deviating from roads in a method lower in precision, but simpler than the technique disclosed in Patent Literature 1 and Patent Literature 2, depending on the environment. For example, a method for traveling along a line of the street trees or the power poles, or the unevenness of roadsides is conceivable. The shapes of the street trees, the power poles, and the unevenness of the roadsides are substantially determined, and objects can be discriminated even if the individual shape data is not measured in advance. Therefore, if the number or a rough layout of those components is found, those pieces of information (the number of street trees, power poles, and the unevenness of the roadsides, and the rough positions) can be used as marks of the positions. The number of street trees, power poles, and the unevenness of the roadsides, and the rough positions can be obtained by seeing, for example, existing road maps or snapshots even if an expensive sensor is not used. Therefore, there is a possibility that general users can simply register the map data, and can create the extensive map data promptly.

However, that the street trees, the power poles, and the unevenness of the roadsides are used as the mark to conduct the localization leads to a risk that the localization precision is reduced. The reduction in the localization precision may lead to meandering or speed instability, and is not preferable. Therefore, finally, the localization with as high precision over the overall area as possible is desirable.

Also, as a status in which the general users register the map data, it is conceivable, for example, that a person who wishes to use the autonomous mobile device acquires information to be marked in the route around his house or frequently used by himself, and adds the acquired information to a map database. In this case, it is not preferable that the map database is published as it is, from the viewpoint of privacy or security.

Also, there are environments in which the localization can be conducted with relatively high precision, without using the expensive sensor, depending on a place such as roads having a clear feature and a simple shape. Therefore, in the autonomous mobile device used under only such environments, the sensor configuration may become inexpensive. However, under the existing conditions, an environment in which everybody easily studies the minimum sensor configuration for obtaining a necessary localization precision under a specific environment before the autonomous mobile device is introduced is not prepared.

The present invention has been made in view of the above background, and an object of the present invention is to support the expansion of information used for travel of an autonomous mobile device.

### Solution to Problem

In order to solve the above problem, according to the present invention, a localization precision is calculated through a sensor on the basis of sensor data collected during travel to update the localization precision stored in a storage unit. Other solutions are appropriately described in embodiments.

### Advantageous Effects of Invention

According to the present invention, the expansion of information used for travel of the autonomous mobile device can be supported.

### BRIEF DESCRIPTION OF DRAWINGS

FIG. 1 is a diagram illustrating one configuration example of an autonomous mobile device according to a first embodiment.

FIG. 2 is a conceptual view of area (No. 1).

FIG. 3 is a conceptual view of area (No. 2).

FIG. 4 is a diagram illustrating one specific example of travel path information (No. 1).

FIG. 5 is a flowchart illustrating a procedure of processing in the autonomous mobile device according to the first embodiment.

FIG. 6 is a diagram illustrating another configuration example of the autonomous mobile device according to the first embodiment (No. 1).

FIG. 7 is a diagram illustrating still another configuration example of the autonomous mobile device according to the first embodiment (No. 2).

FIG. 8 is a diagram illustrating one configuration example of an autonomous mobile device according to a second embodiment.

FIG. 9 is a diagram illustrating another specific example of the travel path information (No. 2).

FIG. 10 is a diagram illustrating still another specific example of the travel path information (No. 3).

FIG. 11 is a flowchart illustrating one procedure of processing in the autonomous mobile device according to the second embodiment (No. 1).

FIG. 12 is a flowchart illustrating another procedure of processing in the autonomous mobile device according to the second embodiment (No. 2).

FIG. 13 is a flowchart illustrating a procedure of registration according to mark information by a general registrant.

FIG. 14 is a diagram illustrating a configuration example of an autonomous mobile system according to a third embodiment.

FIG. 15 is a flowchart illustrating a procedure of map data determination processing according to the third embodiment.

### DESCRIPTION OF EMBODIMENTS

Subsequently, modes (called “embodiments”) for carrying out the present invention will be described in detail appropriately with reference to drawings. In the respective drawings, the same components are denoted by identical symbols, and their repetitive description will be omitted.

### First Embodiment

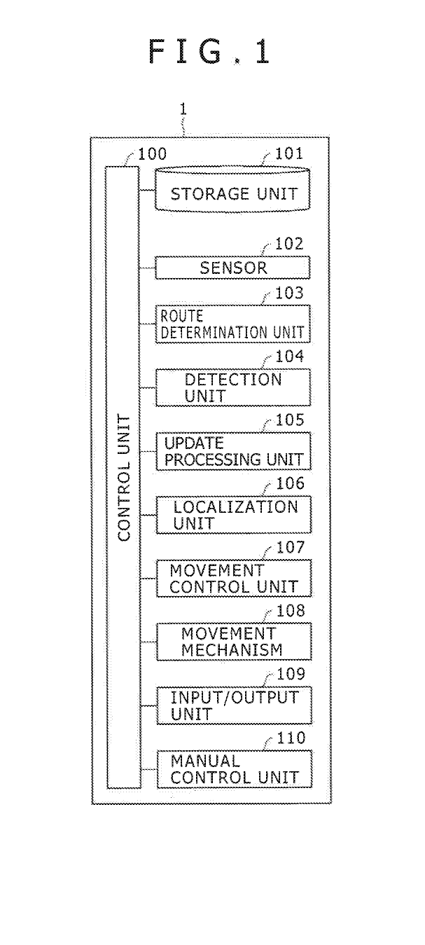

First, a first embodiment of the present invention will be described with reference to FIGS. 1 to 7.

Configuration of Autonomous Mobile Device

FIG. 1 is a diagram illustrating one configuration example of an autonomous mobile device according to a first embodiment.

An autonomous mobile device 1 includes a control unit 100, a storage unit 101, sensors 102, a route determination unit 103, a detection unit 104, an update processing unit 105, a localization unit 106, a movement control unit 107, a movement mechanism 108, an input/output unit 109, and a manual control unit 110. In this embodiment, it is assumed that the autonomous mobile device 1 is of a type in which a person rides thereon (ride-on type), but may be unmanned.

The control unit 100 conducts an overall control of the autonomous mobile device 1.

The storage unit 101 stores various information such as travel path information (to be described later) which will be described later, sensor data (data of laser scan, an image of a camera provided in the autonomous mobile device 1, and positional information by a GPS), map data that is compared with the sensor data to localize a self-position, route information, and mark information therein. The mark information will be described later.

The sensors 102 are configured by the GPS, the laser scan, an encoder used for wheel odometry, a camera, or a stereo camera.

The route determination unit 103 determines a route along which the autonomous mobile device 1 moves. The route determination unit 103 determines a route from a departure place to a destination with reference to one or more travel path information stored in the storage unit 101, and the map data. The determination of the route is conducted with the use of various existing route search algorithms, and therefore a detailed description thereof will be omitted.

The detection unit 104 detects a mark according to the sensor data or the like obtained from the sensors 102.

The update processing unit 105 calculates a self-position localization precision which is a precision when localizing the self-position on the basis of information of the obtained sensor data, and updates various information such as the travel path information.

The localization unit 106 localizes the present self-position during travel.

The movement control unit 107 determines a travel direction on the basis of the present self-position localized by the localization unit 106, and the route information, and controls the movement mechanism 108 to autonomously move the autonomous mobile device 1.

The movement mechanism 108 is configured by, for example, wheels, legs, or a driving device (motor), and moves the autonomous mobile device 1 toward the travel direction.

The input/output unit 109 is an information input display device such as a touch panel display for displaying information for a user, and inputting necessary information.

The manual control unit 110 is configured by a joystick or a handle for allowing a user (passenger) of the autonomous mobile device 1 to manually indicate the travel direction of the autonomous mobile device 1.

Area

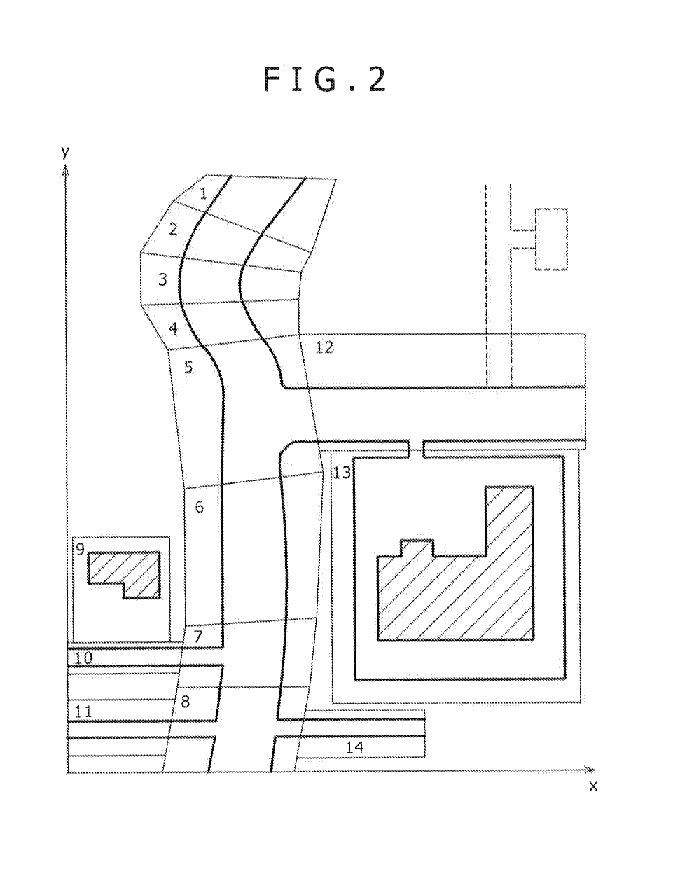

FIG. 2 is a conceptual view of an area.

As illustrated in FIG. 2, in the travel path information, a region in which the autonomous mobile device 1 travels is managed for each of areas indicated by thin lines. In this example, in FIG. 2, thick lines indicate the travel paths, batched lines indicate structures, and the thin lines indicate boundaries of the areas. Also, numbers described in the respective areas are area Nos. for identifying the areas. Further, as illustrated in FIG. 2. Positions of the travel path are represented by a x-y coordinates. Specifically, the x-y coordinates may be lat/long, or may be any coordinate system including a plane orthogonal coordinate system with an arbitrary position as an origin. Also, for simplifying a travel method within the areas, it is preferable that each curve is divided into fine areas so that a travel path within one area enables straight travel. Also, it is preferable that a branched place is divided into one area so that branched directions are simply indicated even in the branched place. The division of areas may be conducted by a manager, or may be considered by automatic division through an automatic division algorithm.

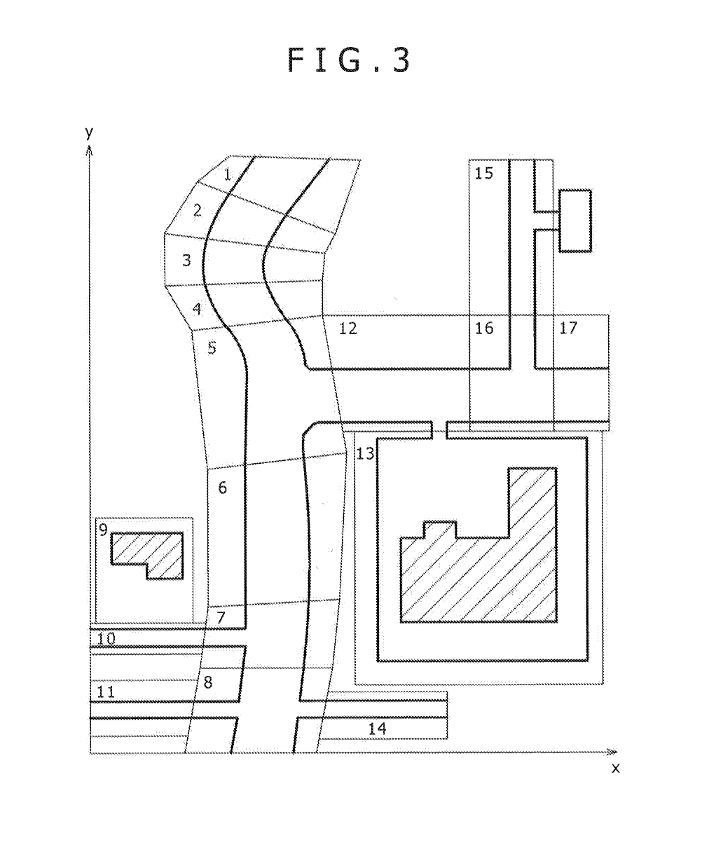

Also, as illustrated in FIG. 3, when a travel path not stored in the travel path information is detected by the autonomous mobile device 1, the travel path information may be updated by generating a new area, or the manager may set a new area or the travel path information. For example, areas “15”, “16”, and “17” in FIG. 3 have not been set in a stage of FIG. 2, but are newly added. Also, in FIG. 3, since the number of branches is increased in area “12” of FIG. 2, the area “12” is divided, and the areas “16” and “17” are newly set. Dashed portions in FIG. 3 are portions in which the travel paths are not set.

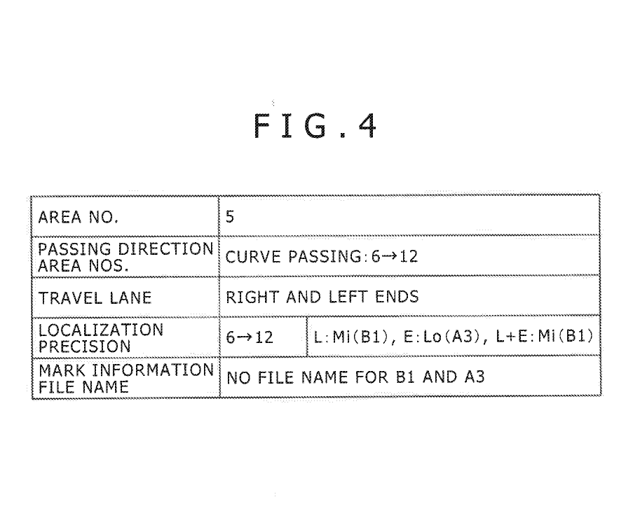

FIG. 4 is a diagram illustrating one specific example of the travel path information. FIG. 2 is arbitrarily referred.

The travel path information may be created as initial information by the manager with reference to a map acquired through the Internet, or the travel path information created by another autonomous mobile device 1 may be used as the initial information. Then, data necessary for the travel path information is added with the travel of the autonomous mobile device 1, to thereby expand the travel path information.

As illustrated in FIG. 4, the travel path information includes the area No., passing direction area No., a travel lane, a localization precision, and a mark information file name.

The area No. is an area No. of a target area in the travel path information, and indicates the travel path information related to an area “5” in the example of FIG. 4. Thus, the travel path information is generated for each of the areas. The area No. “5” corresponds to the area No. “5” in FIG. 2.

The passing direction area Nos. indicate area Nos. before and after passing through the target area when the autonomous mobile device 1 moves on the route. In this description, it is assumed that when a departure place in an area “9” (hereinafteer, the area No. is based on the area No. in FIG. 2), and a destination is an area “13”, a route determined by the route determination means 3 goes through the travel path areas “9”, “10”, “7”, “6”, “5”, “12”, and “13” in the stated order. In this route, when the autonomous mobile device 1 passes through the area “5”, the autonomous mobile device 1 enters the area “5” from the area “6”, and passes through the area “12”. Therefore, the autonomous mobile device 1 refers to the travel path information in which the passing area Nos. area curve passing “from 6 to 12” as illustrated in FIG. 4.

Also, the travel lane is a travelable position in the target area, and an end, a center, the overall, and right and left ends of the travel path, or the overall road is stored in the travel lane. For example, when the autonomous mobile device 1 can travel on sidewalks on both sides of the street, the travel lane become the right and left ends as shown in the example of FIG. 4. Also, if the road is narrow, the travel lane is the overall road.

In the localization precision, a precision when the autonomous mobile device 1 localizes the self-position in an appropriate area is stored. In the example of FIG. 4, “L” means laser scan, and “E” means an encoder of a wheel. Also, “Mi” means a middle precision (middle), and “Lo” means a low precision (low). Also, “A3” means “localization system by a wheel odometry”, and “B1” means “localization system by travel along the unevenness of the roadsides”.

That is, in the example of FIG. 4, “L:Mi(B1)” means that the self-position localization by “the localization system by travel along the unevenness of the roadsides with the use of the laser scan” is enabled, and the precision is “middle precision”. Likewise, “E:Lo(A3)” means that “localization system by the wheel odometry with the use of the encoder” is enabled in the appropriate area, and the precision is “low precision”. Also, “L+E:Mi(B1)” means that “localization system by travel along the unevenness of the roadsides with the combination of the laser scan with the encoder” is enabled in the appropriate area, and the precision is “middle precision”.

The localization precision is sequentially updated while the autonomous mobile device 1 travels.

In an area where the autonomous mobile device 1 has not yet actually traveled, the manager may preferably obtain the localization precision by weighting from experience on the basis of the mark information that has been registered when the autonomous mobile device 1 has traveled previously, and the type (that is, the laser scan, the encoder, or the GPS) of the sensors 102. The mark information will be described later. In an area where the autonomous mobile device 1 has actually traveled, the update processing unit 105 may obtain the localization precision on the basis of a travel state. For example, the localization precision is calculated as “high precision (Hi: high)” if the autonomous mobile device 1 can smoothly travel, as “middle precision (Mi)” if the autonomous mobile device 1 bucks, and as “low precision (Lo)” if the autonomous mobile device 1 travels while frequently stopping. Since the localization precision is different depending on the passing direction such as going straight or turning a corner, an appropriate passing direction (“from 6 to 12” in FIG. 4) is added to the localization precision.

The mark information file name is a file name of a file in which the mark information used in the available localization system in the appropriate area (in the example of FIG. 4, “A3: localization system by the wheel odometry”, and “B1: localization system by travel along the unevenness of the roadsides”) is stored. In the example of FIG. 4, the file of the mark information used in the localization system name of “B1”, which means that there is no file used in “A3”, that is, “the localization system by the wheel odometry”. This is because the wheel odometry localizes the self-position according to a travel distance calculated on the basis of the rotation of the wheel, and therefore the mark information is unnecessary.

In this example, the mark information is used when localizing the self-position. For example, in the case of “localization system by the travel along the unevenness of the roadsides”, the mark information is information related to the rough shape of the roadsides, which is extracted from the sensor data. For example, if the self-position is localized with “the localization system by travel along the unevenness of the roadsides” as the localization system, a rough image of the roadsides is extracted from laser scan data (sensor data) by the detection unit 104, and is stored in the storage unit 101 as a file in which the extracted rough image of the roadsides is described in a column of the mark information file name.

In this way, the mark information has necessary information different according to the localization system. For example, in a 3D environment shape which matching travel, information related to the 3D environmental shape which becomes a mark is necessary. In a street corner sign recognition system, information related to the type, height, and size of the sign which becomes a mark is necessary.

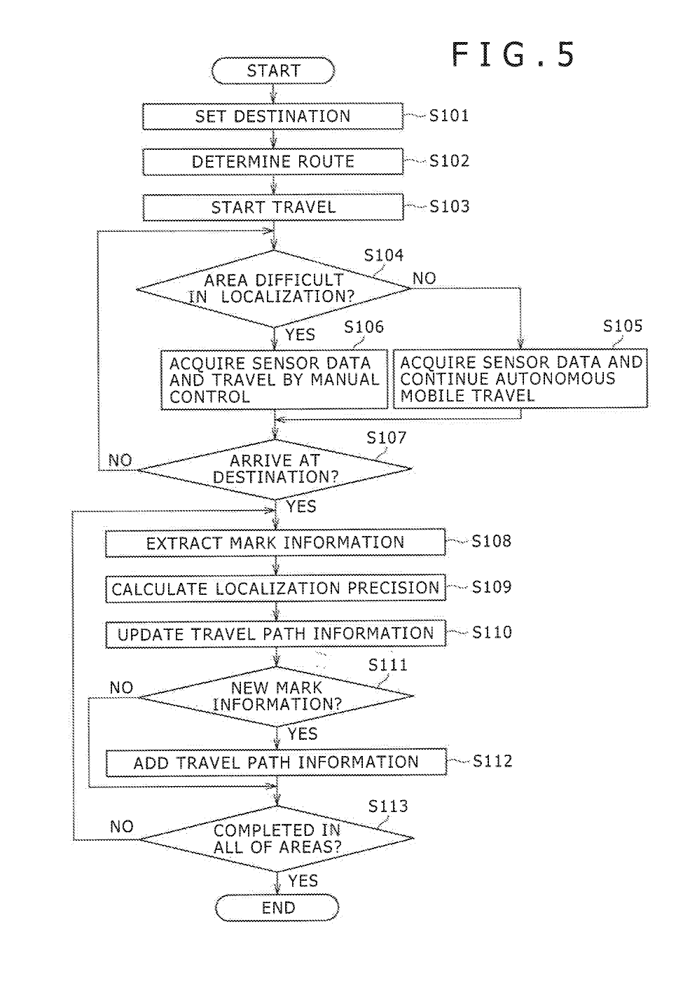

FIG. 5 is a flowchart illustrating a procedure of processing in the autonomous mobile device according to the first embodiment. FIG. 1 is appropriately referred to.

First, the passenger of the autonomous mobile device 1 sets destination information through the input/output unit 100 to set the destination (S101). The destination information is, for example, coordinates on the map.

Then, the route determination unit 103 determines a route from the present place to the destination (S102). The route determination method is an existing technique as described above, and therefore a description thereof will be omitted.

Then, the movement control unit 107 starts travel (S103).

During travel, the sensors 102 sense a movement environmental area to acquire the sensor data, and detects a feature of the mark from the sensor data, and a position of the mark within the sensor data (within an image).

The localization unit 106 localizes the present self-position on the basis of a detection result of the mark from the detection unit 105, and the movement control unit 107 controls the movement mechanism 108 on the basis of the localized result, to thereby conduct travel. In this situation, the sensor data is stored in the storage unit 101. The sensor data stored in the storage unit 101 may collect all of the areas, or collect only the areas describing that the localization precision is low in the travel path information.

The localization unit 106 periodically confirms whether the area where the autonomous mobile device 1 is currently traveling is an area low in the localization precision, or an area in which the self-position localization cannot be conducted (called “area difficult in localization” in a lump), or not (that is, whether the localization precision is equal to or lower than a given precision, or not), during travel (S104). In this example, when the localization precision of the traveling area is set, the localization unit 106 determines whether the highest localization precision in the localization precision of the travel path information illustrated in FIG. 4 in the presently used localization system is low, or not. For example, in the example of FIG. 4, since “middle precision (Mi)” is the highest localization precision, the localization unit 106 conducts the processing in Step S104 when it is assumed that the localization precision in the appropriate area is “middle precision”. The area in which the self-position localization cannot be conducted is an area in which all of the sensors 102 cannot be used in the travel path information, and it is determined that the self-position cannot be localized. That is, the area in which the self-position localization cannot be conducted is an area in which a column of the localization precision in FIG. 4 is blank (in other words, the localization precision is “0”).

As a result of Step S104, if the currently traveling area is not the area difficult in localization (no in S104), the movement control unit 107 continues the autonomous mobile travel while acquiring the sensor data (S105), and the proceeds to Step S107.

As a result of Step S104, if the currently traveling area is the area difficult in localization (yes in S104), the control unit 100 switches the travel method to the manual control, and the movement control unit 107 conducts travel by the manual control while acquiring the center data (S106). That is, because the currently traveling area is the area difficult in localization, the control unit 100 stops the autonomous mobile travel, and switches the travel method to the manual control. Specifically, a display screen for promoting the manual control by the passenger is displayed on the input/output unit 109, and the passenger conducts the control by the manual control unit 110. If the currently traveling area enables the self-position localization, but is low in precision, the autonomous mobile travel may be conducted according to a passenger's intention. In this case, for example, a display screen saying “Please touch this button” in response to “Is autonomous mobile travel continued?” is displayed in the input/output unit 109. If the passenger touches the button, the movement control unit 107 may conduct the autonomous mobile travel. However, if such travel is conducted, because the localization precision is low, there may be a need to travel while frequently correcting the travel position with the use of the obstacle avoidance function. Therefore, it is preferable that the movement control unit 107 allows the autonomous mobile device 1 to travel at a low speed.

The localization unit 106 periodically determines whether the autonomous mobile device 1 arrives at the destination, or not, during travel, on the basis of the present position and the destination information (S107).

As a result of Step S107, if the autonomous mobile device 1 does not arrive at the destination (no in S107), the control unit 100 returns the processing to Step S104.

As a result of Step S107, if the autonomous mobile device 1 arrives at the destination (yes in S107), the control unit 100 starts update processing of Steps S108 to S115.

First, the detection unit 104 extracts various mark information from the sensor data stored in the storage unit 101 for each of the areas (S108).

Subsequently, the update processing unit 105 calculates the localization precision for each type of mark information on the basis of the extracted mark information and the travel speed at that time (S109). The method of calculating the localization precision is described above.

The update processing unit 106 updates a column of the localization precision in the appropriate localization system among the travel path information of the appropriate area to a new localization precision (S110).

Subsequently, the update processing unit 105 determines whether the mark information extracted in Step S108 is new mark information of the type not yet registered, or not (S111).

As a result of Step S111, if the extracted mark information is not the mark information of the type not yet stored in the storage unit 101 (no in S111), the update processing unit 105 skips the processing of Step S112.

As a result of Step S111, if the mark information of the type not yet stored in the storage unit 101 is detected (yes in S111), the update processing unit 105 adds the localization precision of the newly detected mark information to the travel path information (S112). Also, the information related to the newly extracted mark information is stored in the storage unit 101.

The control unit 100 determines whether the update processing of Steps S108 to S112 has been completed for all the areas, or not (S116).

As a result of Step S115, if there is an area in which the update processing is not completed (no in S115), the control unit 100 returns the processing to Step S108, and update a next area.

As a result of Step S115, if the update processing has been completed for all of the areas (yes in S115), the control unit 100 finishes the processing.

In the first embodiment, all of the localization precision are updated, but if the calculated localization precision is higher than the currently stored localization precision, the update processing unit 105 may update the localization precision of the appropriate area to the newly calculated localization precision.

### Modification of First Embodiment

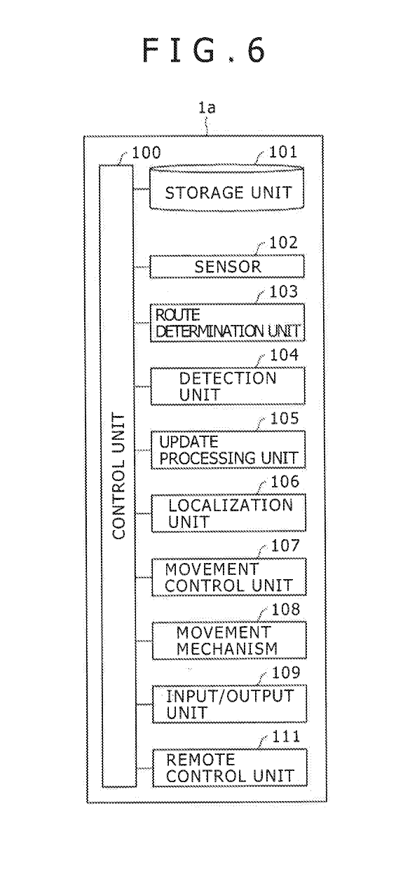

FIG. 6 is a diagram illustrating another configuration example of the autonomous mobile device according to the first embodiment. Referring to FIG. 6, the same components as those in FIG. 1 are denoted by identical symbols in FIG. 1, and a description thereof will be omitted.

An autonomous mobile device 1a in FIG. 6 is different from the autonomous mobile device 1 of FIG. 1 in that the manual control unit 110 is replaced with a remote control unit 111.

If the area in which the autonomous mobile device 1a travels is the area difficult in localization (yes in S104 of FIG. 5), the travel by the remote control is presented to the passenger by the input/output unit 109. If the passenger selects the travel by the remote control, the movement control 107 allows the autonomous mobile device 1a to travel by the remote control using radio instead of the autonomous travel. Even during the travel by the remote control, the sensors 102 continue to acquire the sensor data. The remote control is conducted by family staying at home or remote operator present in a remote control center. The remote control unit 111 is equipped with a camera, a communication device, and a control device, and a person who conducts remote control conducts a wireless communication to conduct the operation while viewing an image of the circumferential environment of the autonomous mobile device 1a by the camera. The method of thus conducting the remote control in the area difficult in localization is suitable for children or older persons concerned about safety of their operation.

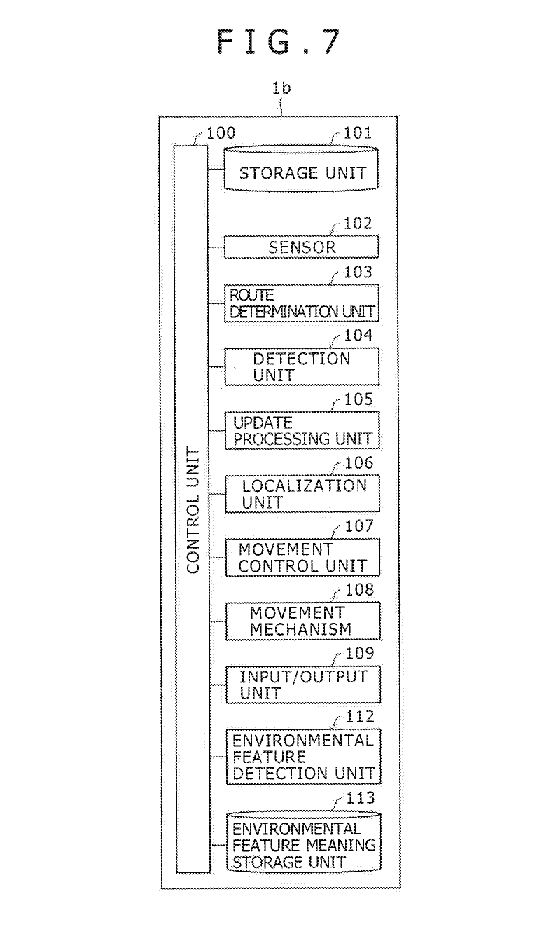

FIG. 7 is a diagram illustrating still another configuration example of the autonomous mobile device according to the first embodiment. Referring to FIG. 7, the same components as those in FIG. 1 are denoted by identical symbols in FIG. 1, and a description thereof will be omitted.

An autonomous mobile device 1b illustrated in FIG. 7 includes an environmental feature detection unit 112 that detects the environmental features which are information related to travel which are installed on the travel path, and an environmental feature meaning storage unit 113 that associates the environmental features with their meanings in the movement environment, instead of the manual control unit 110 in the autonomous mobile device illustrated in FIG. 1.

The environmental features are signs, symbols, or signboards.

If the localization precision of the area where the autonomous mobile device 1 is currently traveling is the area difficult in localization (yes in S104 of FIG. 5), the environmental feature detection unit 112 reads the environmental features and their meanings which are stored in the environmental feature meaning storage unit 113, and extracts the environmental features and their meanings from the sensor data such as an image picked by the camera provided as one of the sensors 102. The movement control unit 107 conducts the autonomous travel on the basis of the extracted meanings. That is, the autonomous mobile device 1b of FIG. 7 controls travel according to the sign such as one way in the area difficult in localization.

In this travel method, because it takes long time to detect the environmental feature, meandering is conducted with low precision, or bucking is conducted, it is desirable that the movement control unit 107 sets the travel speed to be low as occasion demands.

With the application of this method, the autonomous mobile device 1b can conduct the autonomous travel even in the area difficult in Localization.

As described above, the autonomous mobile device 1 according to the first embodiment can update the mark information and the localization precision of the travel path information on the basis of the sensor data obtained during travel. This make it possible to improve the localization precision and expand the mark information, and conduct smoother travel.

Also, the autonomous mobile device 1 according to the first embodiment can use other methods (manual control, remote control, and travel by environmental feature detection) in the area difficult in the localization even if the localization precision is not high or middle in the all of the areas in the route. Therefore, a load when the autonomous mobile device 1 is introduced is reduced. That is, the travel corresponding to the localization precision can be conducted for each of the areas.

### Second Embodiment

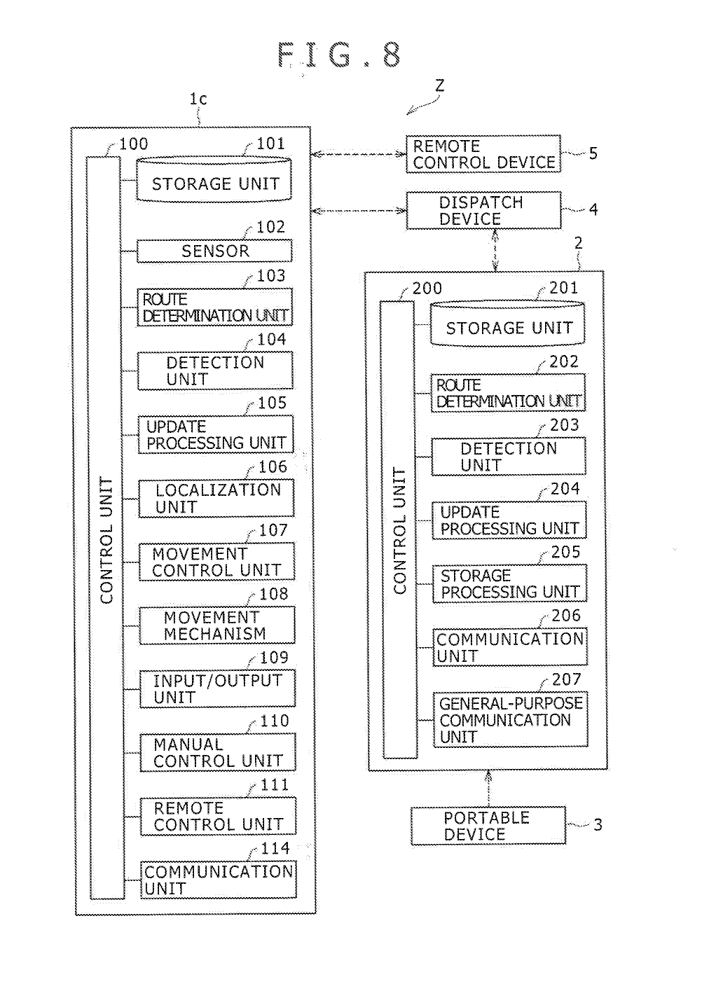

Subsequently, a second embodiment of the present invention will be described with reference to FIGS. 8 to 13. In the second embodiment, the mark information and the travel path information are expanded on the basis of images that have been registered by general registrants (general registrants) through a network.

FIG. 8 is a diagram illustrating one configuration example of an autonomous mobile device according to the second embodiment. Referring to FIG. 8, the same components as those in FIG. 1 are denoted by the identical symbols, and a description thereof will be omitted.

An autonomous mobile system Z includes an autonomous mobile device 1c, a management device 2, a dispatch device 4, and a remote control device 5.

The autonomous mobile device 1c includes the remote control unit 111 of FIG. 6, and a communication unit 114 that conducts a communication with the management device 2 and the dispatch device 4, in addition to the configuration of the autonomous mobile device 1 of FIG. 1.

The management device 2 extracts the mark information on the basis of the image transmitted from a portable device (communication device) 3 provided by the general registrant, and calculates and manages the localization precision. Also, the management device 2 transmits information to the dispatch device 4 or the autonomous mobile device 1c as occasion demands. The portable device 3 is a cellular phone with a camera, a smartphone, or a PC with a camera.

The management device 2 includes a control unit 200, a storage unit 201, a route determination unit 202, a detection unit 203, an update processing unit 204, a storage processing unit 205, a communication unit 206, and a general-purpose communication unit 207.

The control unit 200 controls the overall autonomous mobile device 1c.

The storage unit 201 stores various information such as travel path information (to be described later) which will be described later, the mark information, and the image transmitted from the portable device 3 therein.

The route determination unit 202 determines a route on which the autonomous mobile device 1c travels. The route determination unit 202 determines a route from a departure place to a destination with reference to one or more travel path information and the map data which are stored in the storage unit 201. Because various route search algorithms are developed, a detailed description of the determination of the route will be omitted.

The detection unit 203 detects the mark information from the image transmitted from the portable device 3.

The update processing unit 204 calculates the self-position localization precision on the basis of the image transmitted from the portable device 3, and updates various information such as the travel path information.

The storage processing unit 205 stores various information in the storage unit 201.

The communication unit 206 conducts a communication with the autonomous mobile device 1c.

The general-purpose communication unit 207 conducts a communication with the portable device 3 through the Internet or a wireless phone line.

The dispatch device 4 conducts processing related to dispatch of the autonomous mobile device 1c upon receiving an instruction from the portable device 3. The dispatch device 4 is necessary when the autonomous mobile device 1c is shared by a plurality of persons, but may be omitted.

Also, the dispatch device 4 may also communicate with the management device 2, acquires information on whether an area in which the self-position localization cannot be conducted because the precision is low or the mark information is not acquired, is present on the route, or not, and transmits the acquired information to the autonomous mobile device 1c. Further, the dispatch device 4 communicates with the autonomous mobile device 1c, and issues, to the autonomous mobile device 1c, and autonomous mobile instruction to the departure place, and a feedback instruction from the destination to a waiting place as occasion demands.

The remote control device 5 is a device for remote-controlling the autonomous mobile device 1c.

Travel Path Information

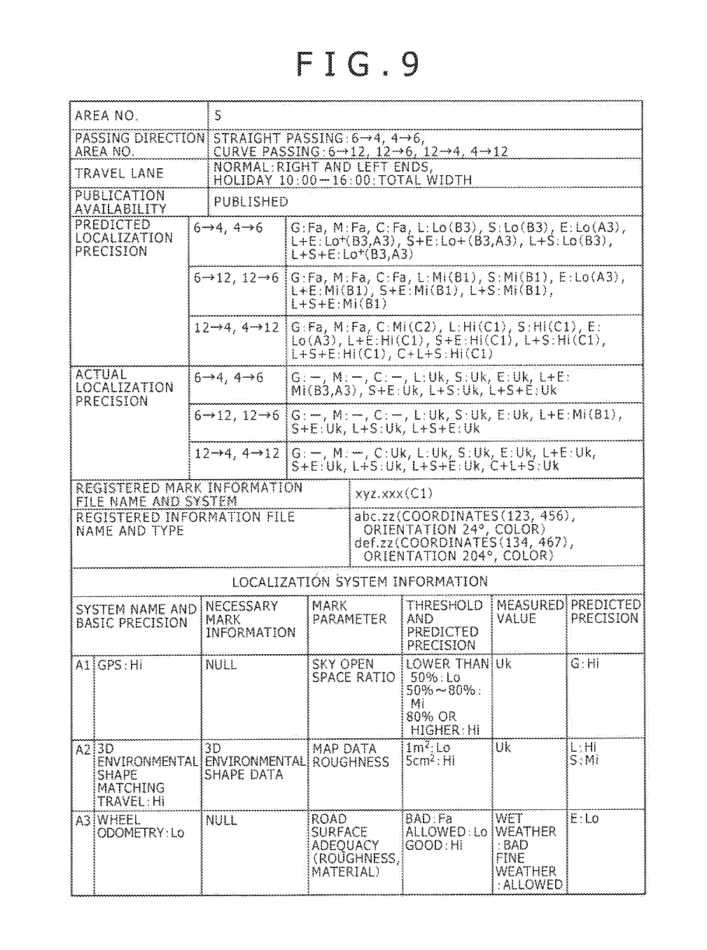

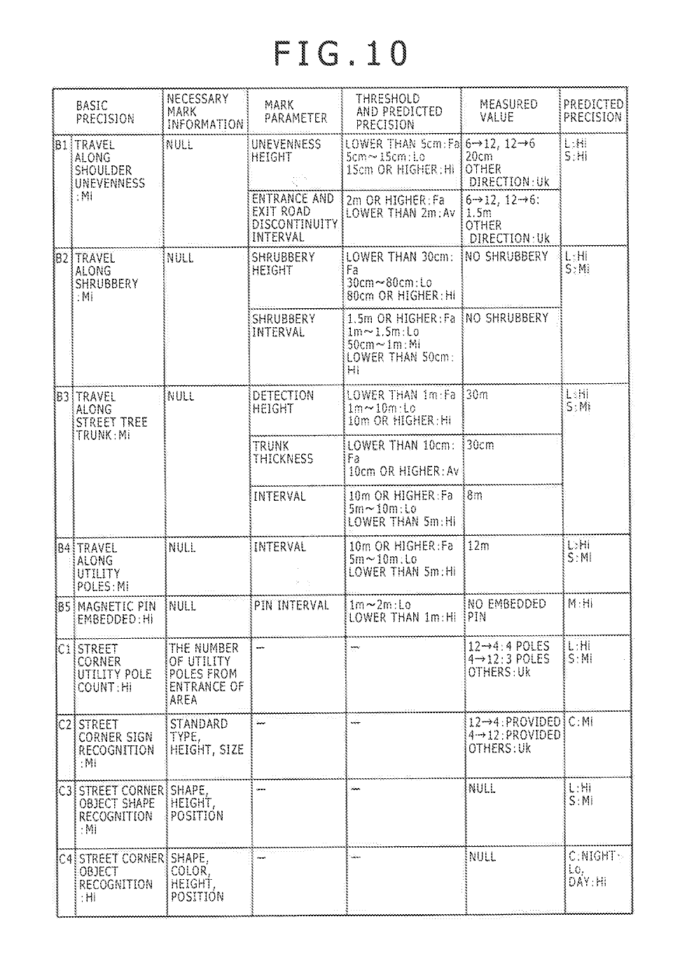

FIGS. 9 and 10 are diagrams illustrating specific examples of the travel path information.

An area No. is an area No. of a target area of the travel path information as in FIG. 4, and an example of FIG. 9 shows the travel path information related to the area “5”. The area Nos. in FIGS. 9 and 10 correspond to the area No. of FIG. 2.

A passing direction area No. describes area Nos. before and after the target area when the autonomous mobile device 1c travels on the route as in FIG. 4. In the example of FIG. 9, unlike the example of FIG. 4, a plurality of passing area Nos. is described. This shows that the travel path information related to the plurality of passing areas is collected up. FIGS. 9 and 10 show a sequence of data.

The travel lane is travelable position in the target area as in the example of FIG. 4. In an example of FIG. 9, there is information of “holiday 10:00-16:00 total width”, which means that the area “5”, is travelable over a total width at 10:00 to 16:00 of Sunday and holidays.

Publication availability is information related to publication of the mark information, and may include three patterns of published, unpublished, and registration refusal, but may include other information.

In this example, the publication means that the mark information is available by everybody, the unpublication means that the mark information is available by only specific persons, and the registration refusal means that the mark information cannot be registered. In the case of nonpublication, a password or the other authentication means is provided, and the mark information is available only when the person is authenticated before mark information is used.

Information on the publication availability is intended for protection of the owner's privacy of a private land area, or security, and a right to set the publication availability information may be given the owner of the private land area. The registration refusal means that registration into the storage unit 201 is refused in order to prevent the shape information from being leaked even if there is an unauthorized access to data within the storage unit 201.

The localization precision includes a predicted localization precision and an actual localization precision, and information is stored in each of the passing direction area Nos.

The predicted localization precision is a localization precision which is predicted, and the actual localization precision is a localization precision which is calculated on the basis of the actual sensor data.

In the predicted localization precision and the actual localization precision, “G” is GPS, “M” is a magnetic sensor, “C” is a color camera, “L” is a laser scan, and “E” is the respective sensors 102 of the encoder. “L+E” shows the combination of the appropriate sensors 102. Those sensors 102 are also applicable to the first embodiment.

Also, in the predicted localization precision and the actual localization precision, “Hi” is high precision (high), “Mi” is a middle precision (middle), “Lo” is low precision (low), “Fa” is failure (failure), “Uk” is unknown (unknown), and “-” is not acquired. Further, the localization precision includes precisions such as high precision + (Hi+), middle precision (Mi+), and low precision (Lo+). Those localization precisions are also applicable to the first embodiment. The failure means that the appropriate sensors 102 cannot be used in the appropriate area because of the environmental conditions, and the non-acquisition means that the sensor data is not acquired because the sensors 102 cannot be used.

In the predicted localization precision, a predetermined predicted precision is described in localization system information which will be described by the management device 2 on the basis of the predetermined predicted precision in the localization system information, and may be input by the manager.

The actual localization precision is determined by the management device 2 on the basis of a state in which the autonomous mobile device 1c travels by the appropriate localization system, with the use of the appropriate sensors 102. For example, if the autonomous mobile device 1c can smoothly travel, the management device 2 determines the localization precision as “high precision (Hi: high)”. If the autonomous mobile device 1c backs, the management device 2 determines the localization precision as “middle precision (Mi)”. If the autonomous mobile device 1c travels while frequently stopping, the management device 2 determines the localization precision as “low precision (Lo)”.

As the localization precision, the actual localization precision is prioritized.

Also, “A1” and “B3” indicate the localization systems, which correspond to three lines from bottom, and lower of FIG. 9, and the localization systems (GPS, 3D environmental shape matching travel, etc.) of “A1” to “C4” in “the system name and basic precision” of the localization system information in FIG. 10.

In the registered mark information file name and the system, a file name in which the extracted mark information is stored, and a localization system are described. In the example of FIG. 9, the localization system is stored in a file where the mark information used in “C1: street corner utility model count” is “xyz.xxx”.

In the registered information file name and the type, the file name in which the image data transmitted from the portable device 3 is stored, and type information related to that image are stored. For example, the image data such as “abc.zz” is an image taken at an orientation 24° to north at a point of coordinates (123, 456), and indicative of color. The coordinates and the orientation are acquired on the basis of the GPS function of the portable device 3 and an electronic level sensor at the time of photographing, and transmitted to the management device 2 together with the image data. In this way, information such as the coordinates and the orientation is stored together with the file name of the image data to register, for example, a plurality of data of a neighborhood area, as a result of which detailed mark information may be obtained. Therefore, if the general registrant is urged to take the image of the neighborhood area, or there is an image obtained by photographing substantially the same object from a slightly distant position, distance information can be obtained by a stereo view.

The third line from bottom of FIG. 9, and the following lines represent localization system information which is information related to the localization system.

The localization system information has a system name, a basic precision, necessary mark information, a mark parameter, a threshold, a predicted precision, a measured value, and a predicted precision.

In the system name and the basic precision, a localization system name, its code, and a limit precision (highest precision) in the self-position localization precision are stored. For example, the self-position localization by GPS (code “A1”) is the self-position localization precision having the highest precision of high precision (Hi). On the contrary, the self-position localization in a wheel odometry (code “A3”) cannot obtain higher than low precision (Lo) at the highest.

The codes “Hi”, “Mi”, “Lo”, “Fa”, and “Uk” in the localization system information have been described in the predicted localization precision and the actual localization precision, and therefore their description will be omitted. Also, “Av” means available (available).

In this example, the localization system using an absolute position is, for example, “A1” to “A3”, and a system in which the autonomous mobile device 1c travels along a certain feature is, for example, “B1” to “B5”. A system in which the autonomous mobile device 1c is curved at the mark is, for example, “C1” to “C4”.

The necessary mark information is a mark necessary for localizing the self-position in the appropriate localization system. For example, the necessary mark information is unnecessary in the localization system using the GPS, but information related to intervals between the respective power poles is necessary in the travel along the power poles in FIG. 10 (mark “4”).

The mark parameter is a parameter giving an indication of the localization precision, and the threshold and the predicted precision are a threshold for calculating the degree of localization precision, and a predicted precision derived from the threshold. For example, the localization precision using the GPS (code “A1”) is calculated on the basis of a sky open space ratio, and determined as low precision (Lo) if the sky open space ration is lower 50%, determined as middle precision (Mi) if the sky open space ratio is 50% to 80%, and determined as high precision (Hi) if the sky open space ratio is equal to or higher than 80%.

The measured value is a value actually measured.

The predicted precision is a limit precision for each of the sensors 102. For example, in the localization system using the GPS (code “A1”), because the used sensors 102 are only the GPS, “G” indicative of the GPS is described in a column of the predicted precision, and the high precision (Hi) which is a limit precision of the GPS is described. On the other hand, in the travel (code “b4”) along the power poles in FIG. 10, the self-position localization can be conducted in two kinds of methods including the laser scan (“L”) and the stereo camera (“S”). These two methods are different in the limit precision, and the limit precision of the self-position localization using the laser scan is high precision (Hi), but the limit precision using the stereo camera is middle precision (Mi). In the basis precision, the lower precision among those predicted precisions is described.

The travel path information in FIGS. 9 and 10 is also applicable to the first embodiment.

(Flowchart)

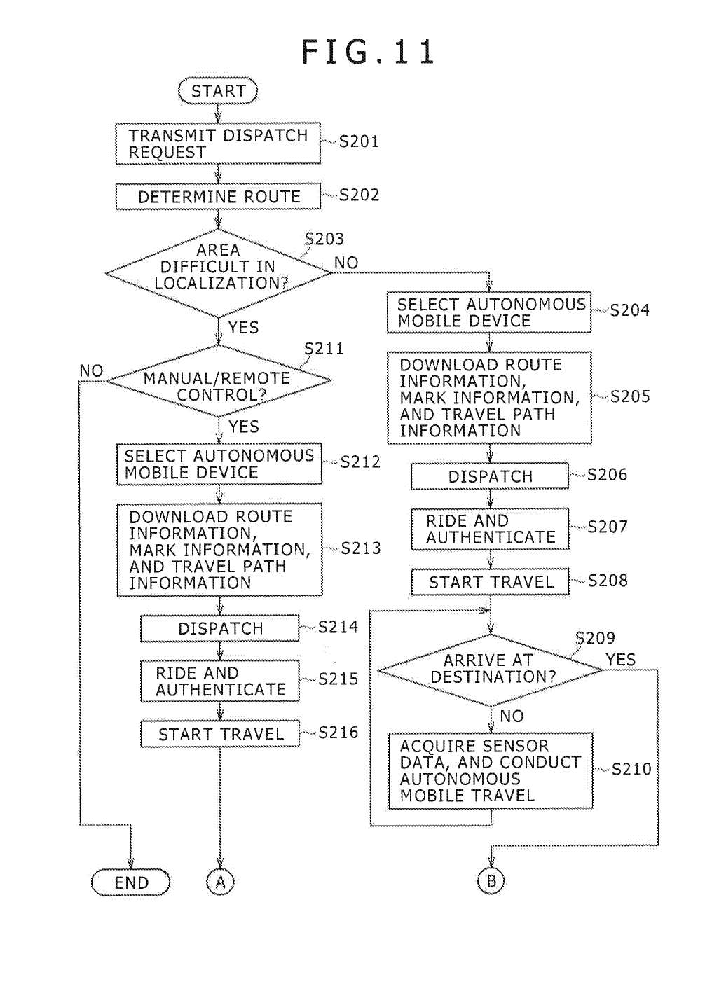

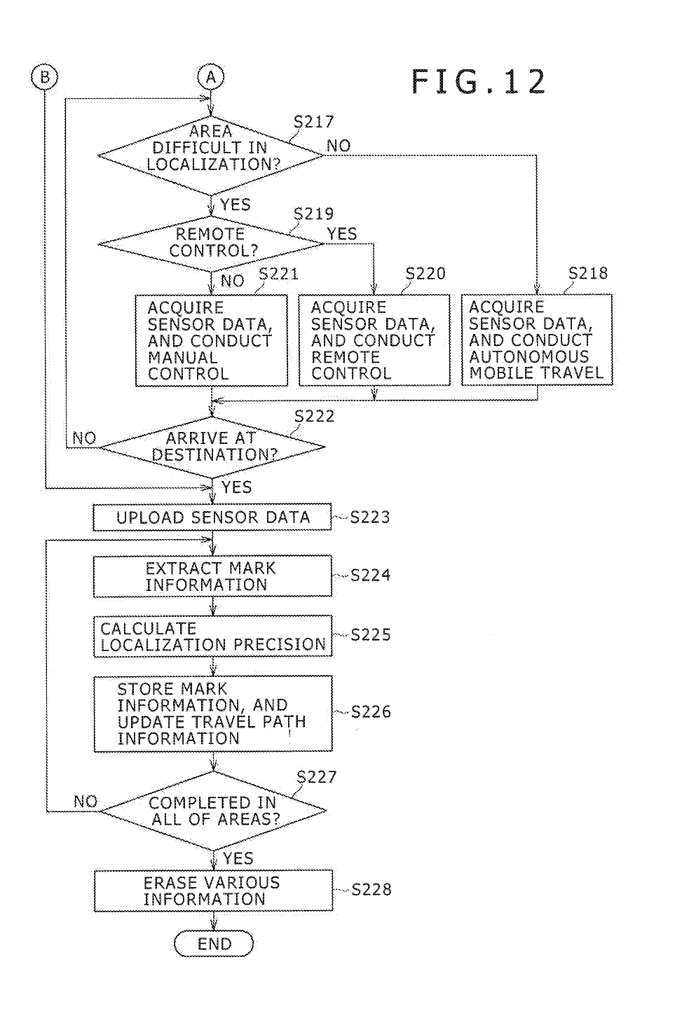

FIGS. 11 and 12 are flowcharts illustrating procedures of processing in the autonomous mobile device according to the second embodiment. A communication between the management device 2 and the autonomous mobile device 1c is conducted through the communication units 114 and 206, but in the description of FIG. 11, a description of the communication will be omitted.

First, the passenger transmits a dispatch request to the dispatch device 4 with the use of PC (personal computer) or a cellular mobile (S201 in FIG. 11). The passenger transmits the dispatch request including information related to a departure place and a destination in the portable device 3.

Then, the dispatch device 4 transmits the information related to the departure place and the destination included in the transmitted dispatch request to the management device 2, and the route determination unit 202 of the management device 2 determines a route from the departure place to the destination (S202).

Then, the route determination unit 202 of the management device 2 determines whether an area in which the localization precision is low, or an area (area difficult in localization) in which the mark information is not acquired, and the self-position localization cannot be conducted, is present on the determined route, or not (S203).

As a result of Step S203, if the area difficult in localization is not present on the determined route (no in S203), the route determination unit 202 of the management device 2 transmits information indicating that the area difficult in localization is not present on the determined route to the dispatch device 4.

The dispatch device 4 that has received the information indicating that the area difficult in localization is not present on the determined route selects an appropriate one of the autonomous mobile devices 1c managed by the dispatch device 4 per se (S204).

Then, the dispatch device 4 transmits a dispatch instruction to the selected autonomous mobile device 1c.

The control unit 100 of the autonomous mobile device 1c that has received the dispatch instruction downloads the route information from the management device 2, and thereafter downloads the mark information necessary for the passing area, and the travel path information satisfying the travel conditions from the management device 2 (S205), and stores the respective downloaded information in the storage unit 101 of the control unit 100.

Then, the movement control unit 107 of the autonomous mobile device 1c autonomously travels to the departure place to conduct dispatch (S206). Even during this dispatch, the movement control unit 107 may acquire the sensor data.

The passenger rides on the dispatched autonomous mobile device 1c, and the control unit 100 authenticates whether the passenger is an identical person, or not, on the basis of the authentication information input from the input/output unit 109 (S207). After the control unit 100 makes unpublished mark information allowed in this authentication among the downloaded mark information available, the movement control unit 107 starts travel toward the destination while conducting the self-position localization by the localization unit 106 (S208). In the mark information, information indicative of whether the mark information can be used for each of appearance requesters, or not, is set.

Also, the localization unit 106 of the autonomous mobile device 1c periodically compares the present position with the travel path information while traveling, and determines whether the autonomous mobile device 1c has arrived at the destination, or not (S209).

As a result of Step S209, if the autonomous mobile device 1c does not arrive at the destination (so in S209), the movement control unit 107 continues the autonomous mobile travel while acquiring the sensor data (S210).

As a result of Step S209, if the autonomous mobile device 1c has arrived at the destination (yes in S209), the control unit 100 of the autonomous mobile device 1c advances the processing to Step S223 of FIG. 12. The processing after Step S223 will be described later.

As a result of Step S203, if the area difficult in localization is present on the determined route (yes in S203), the dispatch device 4 allows a control select screen to be displayed on the input/output unit 109 of the autonomous mobile device 1c, and allows the passenger to select whether the manual control or the remote control (manual/remote control) is conducted, or not, in the area where the precision is low or the self-position localization cannot be conducted (S211). The selection results are transmitted to the dispatch device 4.

As a result of Step S211, if the passenger refuses both methods of the manual and remote controls (no in S211), the autonomous mobile system Z completes the processing.

As a result of Step S211, the passenger selects the manual or remote control (yes in S211), the dispatch device 4 selects the autonomous mobile device 1c having appropriate control means (manual or remote control) (S212), and transmits the dispatch instruction to the selected autonomous mobile device 1c.

After the control unit 100 of the autonomous mobile device 1c that has received the dispatch instruction downloads the route information from the management device 2, the control unit 100 downloads the mark information necessary for the passing area, and the travel path information satisfying the travel conditions from the management device 2 (S213), and stores the respective downloaded information to the storage unit 101 of the autonomous mobile device 1c.

Then, the movement control unit 107 of the autonomous mobile device 1c autonomously moves the autonomous mobile device 1c to the departure place to conduct dispatch (S214).

The passenger rides on the dispatched autonomous mobile device 1c, and the control unit 100 authenticates whether the passenger is an identical person, or not, on the basis of the authentication information input from the input/output unit 109 (S215). After the control unit 100 makes the unpublished mark information allowed by the appropriated authentication among the downloaded mark information available, the control unit 100 starts the travel toward the direction (S216).

The localization unit 106 of the autonomous mobile device 1c periodically determines whether the currently traveling area is an area (area difficult in localization) in which the precision is low, or the self-position localization cannot be conducted, or not, during travel (S217 in FIG. 12).

As a result of Step S217, if the currently traveling area is not the area difficult in localization (no in S217), the movement control unit 107 continues to autonomous mobile travel while acquiring the sensor data (S218), and the control unit 100 of the autonomous mobile device 1c advances the processing to Step S222.

As a result of Step S217, if the currently traveling area is the area difficult to localization (yes in S217), the movement control unit 107 determines whether the control means selected in Step S211 of FIG. 9, is the remote control, or not (S219).

As a result of Step S219, if the remote control is selected (yes in S219), the movement control unit 106 conducts the remote control that accesses to the autonomous mobile device 1c through a communication to control the autonomous mobile device 1c by the remote control unit 111, through a remote controller by an attendant of a remote control service center, while acquiring the sensor data (S220). The control unit 100 of the autonomous mobile device 1c advances the processing to Step S222.

As a result of Step S219, if the remote control is not selected (no in S219), that is, if the manual control is selected, the movement control unit 107 conducts travel by the manual control while acquiring the sensor data, by conducting the manual control by the passenger through the manual control unit 110 (S221).

In both of the remote control of Step S216 and the manual control of Step S217, the movement control unit 106 may acquire the sensor data in only the area difficult in localization except for the registration refusal during travel, and store the sensor data in the storage unit 101.

Also, if the currently traveling area is an area in which the self-position localization can be conducted, but the precision is low, the autonomous mobile travel may be conducted according to the passenger's intention. In this case, for example, a display screen saying “Please touch this button” in response to “Is autonomous mobile travel conducted?” is displayed the input/output unit 109. If the passenger touches the button, the movement control unit 107 may conduct the autonomous mobile travel. However, if such travel is conducted, because the localization precision is low, there may be a need to travel while frequently correcting the travel position with the use of an obstacle avoidance function. Therefore, it is preferable to travel at a low speed.

The localization unit 106 of the autonomous mobile device 1c periodically determines whether the autonomous mobile device 1c arrives at the destination, or not, on the basis of the current position during travel (S222).

As a result of Step S222, if the autonomous mobile device 1c does not arrive at the destination (no in S222), the control unit 100 of the autonomous mobile device 1c returns the processing to Step S217.

As a result of Step S222, if the autonomous mobile device 1c arrives at the destination (yes in S222), the control unit 100 of the autonomous mobile device 1c starts the update processing Steps S223 to S228.

First, the update processing unit 105 of the autonomous mobile device 1c updates the sensor data in the storage unit 101 of the autonomous mobile device 1c to the management device 2 (S223).

Then the detection unit 203 of the management device 2 extracts the various mark information from the updated sensor data for each of the areas (S224). The mark information is extracted for each of the localization system to be used, or each type of the sensors 102 that have acquired the sensor data.

Then, the update processing unit 204 of the management device 2 calculates the localization precision for each type of the mark information on the basis of the extracted mark information (S225). Specifically, the update processing unit 105 calculates the localization precision on the basis of a threshold of the travel path information, a travel state (smooth, bucking, frequent stop), and the extracted mark information. In this example, the calculated localization precision is the actual localization precision in FIGS. 9 and 10.

Then, the storage processing unit 205 of the management device 2 stores the extracted mark information in the storage unit 201 of the management device 2, and stores the calculated localization precision and the publication availability (published/unpublished) in the travel path information to update the travel path information (S226). The information on the publication availability is information input when the general registrant which will be described later transmits the image taken by the portable device 3 to the management device 2. In a stage of Step S226, whether to change the publication availability is conducted so that the update processing unit 105 of the autonomous mobile device 1c confirms the publication availability of the travel path information through the input/output unit 109 by the passenger before updating the sensor data in Step S223, and the confirmation result becomes the information on the publication availability. In this way, the inclusion of information on the publication availability leads to protection of personal information such as home.

The control unit 200 of the management device 2 determines whether the update processing in Steps 224 to S226 has been completed for all of the areas, or not (S227).

As a result of Step S227, if the area in which the update processing is not complete is present (no in S227), the control unit 200 returns the processing to Step S224, and conducts the processing for a next area.

As a result of Step S227, if the update processing is completed for all of the areas (yes in S227), the update processing unit 204 notifies the autonomous mobile device 1c that the registration processing of the mark information and the travel path information has been completed, and the update processing unit 105 of the autonomous mobile device 1c erases the sensor data stored in the storage device of the autonomous mobile device 1c. After the storage processing unit 205 of the management device 2 has erased various information such as the uploaded sensor data and mark information (S223), the autonomous mobile system Z completes the processing, and the movement control unit 107 returns the autonomous mobile device 1c to the dispatch center.

In the second embodiment, in the management device 2, all of the localization precisions are updated. If the calculated localization precision is higher than the currently stored localization precision, the update processing unit 204 of the management device 2 may update the localization precision of the appropriate area to the newly calculated localization precision.

Also, if the mark information of a new type not currently stored is detected, the update processing unit 105 may add the mark information.

Also, in the processing of FIGS. 11 and 12, the management device 2 checks whether the area difficult in localization is present in the route, or not, in advance. Alternatively, as in the first embodiment, the autonomous mobile device 1c may determine whether the currently traveling area is the area difficult in localization, or not, while the autonomous mobile device 1c is traveling.

Also, in the processing of FIGS. 11 and 12, whether the manual control or the remote control is conducted in the area difficult in embodiment, the passenger may be allowed to select whether the manual control or the remote control is conducted after the autonomous mobile device 1c has arrived at the area difficult in localization.

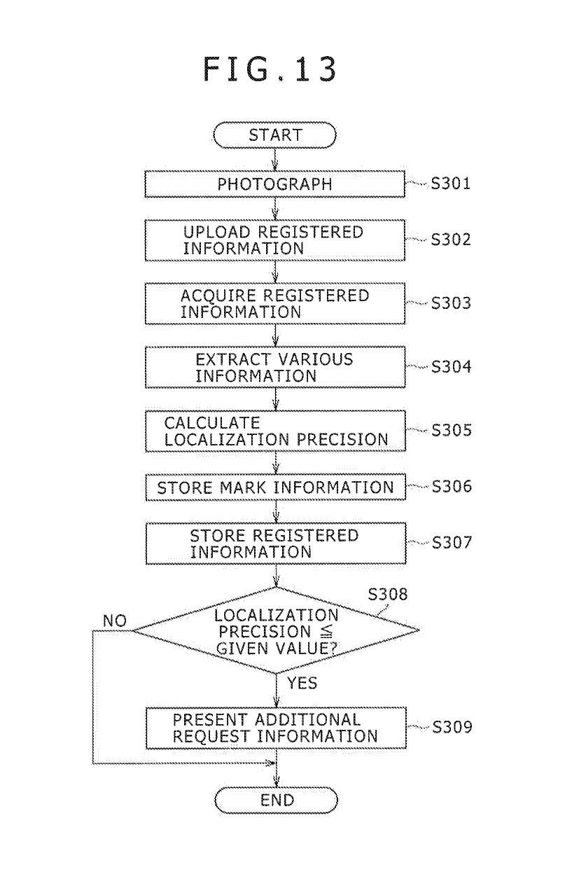

FIG. 13 is a flowchart illustrating a procedure of the registration processing of the mark information by the general registrant.

First, the general registrant takes an image of a place in which the general registrant wishes to autonomously travel by a portable information communication device with a camera (S301). In this situation, if the general registrant takes the image while riding on a bicycle or an automobile, a map of an extensive range can be photographed in a short term.

Then, the general registrant uploads the registered information including the taken image of the management device 2 (S302). In this situation, the general registrant uploads data of a latitude, a longitude, and an orientation with the use of the GPS function of the information communication device with a camera, or the electronic level sensor. Also, the general registrant uploads the publication availability information together with the image. The image, the latitude, the longitude, the route, the orientation, and the publication availability information are called “registered information” in a lamp.

Upon receiving the registered information, the storage processing unit 205 of the management device 2 acquires the neighborhood of the registered information and the registered information previously registered from the registered information registered in the storage unit 201 (S303). Whether the registered information is neighborhood, or not, is determined on the basis of the information such as the latitude and the longitude described in the column of the registered information file name and the type in the travel path information.

Then, the detection unit 203 of the management device 2 extracts the mark information from the uploaded registered information with the use of the uploaded registered information and the registered information of the neighborhood as occasion demands (S304).

Then, based on the extraction results, the update processing unit 204 of the management device 2 calculates the localization precision on the basis of the extracted mark information (S306). The calculation of the localization precision is conducted according to a method of calculating the above-mentioned predicted localization precision.

Then, the storage processing unit 205 of the management device 2 registers various information of the mark information, the localization precision, and the publication availability information in the storage unit 201 (S305). In this example, the localization precision and the publication availability information are stored in the travel path information.

In this situation, the storage processing unit 205 authenticates whether the general registrant is an owner of the appropriate area, or not, and if the appropriate area is a private land owned by the general registrant, it is desirable that the storage processing unit 205 sets the method of the publication availability (FIG. 9) of the travel path information “unpublished” regardless of the intention of the general registrant.

In this example, the storage processing unit 205 stores the uploaded registered information in the storage unit 201 (S307).

In this example, the update processing unit 204 determines whether the localization precision calculated in Step S305 is a given value, or lower (S308).

As a result of Step S308, if the calculated localization precision is larger than a given value (no in S308), the control unit 200 of the management device 2 completes the registration processing of the mark information by the general registrant.

As a result of Step S308, if the calculated localization precision is equal to or lower than the given value (yes in S308), the update processing unit 204 of the management device 2 presents a request (additional request information) of the image data of the position and orientation from which the mark information for improving the localization precision is obtained on the basis of a position and an orientation at which the registered information is imaged to the general registrant (S309). Thereafter, the control unit 200 completes the registration processing of the mark information by the general registrant. The contents presented in Step S309 may be automatically detected by the update processing unit 204, or may be visually detected by the manager who operates the management device 2. The presentation of the additional request information in Step S309 becomes helpful in taking the image by the general registrant next time, and can make the expansion of the mark information and the localization precision more efficient. The processing in Steps S308 and S309 may be omitted, or the update processing unit 204 of the management device 2 may present the additional request image information in Step S309 regardless of the calculated value of the localization precision.

The extraction of the mark information and the calculation of the localization precision may be conducted on the management device 2 side, but may be conducted by the general registrant, and the extraction results may be transmitted to the management device 2. For example, the general registrant may determine whether unevenness is present in the roadsides within the image, or not, how high the unevenness is substantially, and how many power poles is installed between one specific position and another specific position within the image, and transmit the determination result to the management notice 2. Also, the general registrant may be allowed to obtain the travel path information such as information related to the travel lanes.

The autonomous mobile system Z according to the second embodiment obtains cooperation of many persons with the use of the portable devices 3 provided by many persons such as the cellar phones with a camera or smartphones to expand the mark information and the localization precision. Therefore, a labor is not concentrated on the manager, and a person who wishes to use the mark information can register the mark information in a place where the person wishes to see the mark information by himself, resulting in a reduction in the costs.

Also, the autonomous mobile system Z according to the second embodiment adds information on the publication availability to the travel path information to keep the privacy and the security without publishing information on the private land.

### Third Embodiment

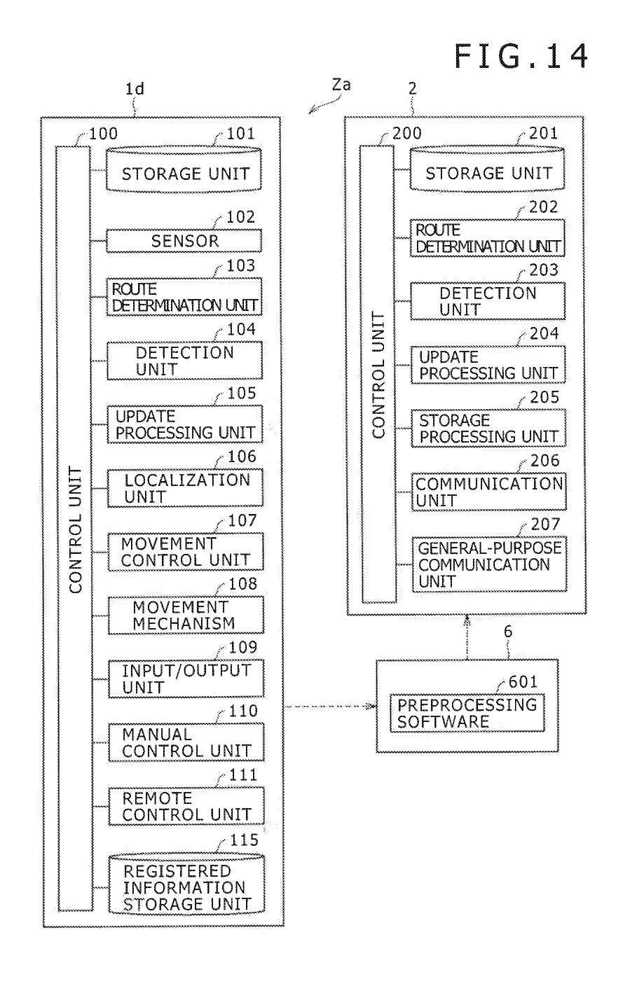

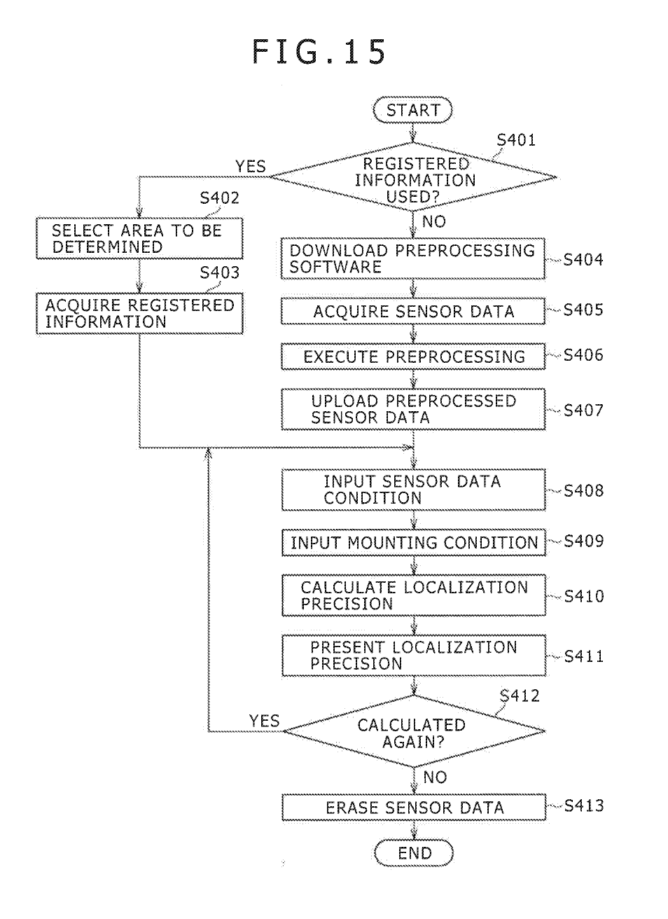

Subsequently, a third embodiment of the present invention will be described with reference to FIGS. 14 and 15. According to the third embodiment, the sensor data is masked when an external is allowed to determine whether an autonomous mobile device 1d can travel, or not, on the basis of the result such as the test travel of the autonomous mobile device 1d.

(System Configuration)

FIG. 14 is a diagram illustrating a configuration example of an autonomous mobile system according to a third embodiment. Referring to FIG. 14, the same components as those in the first embodiment and the second embodiment are denoted by the identical symbols, and a description thereof will be omitted.

An autonomous mobile Za includes the autonomous mobile device 1d, the management device 2, and a preprocessing device 6.

The autonomous mobile device 1d is configured to add a specific information storage unit 115 to the autonomous mobile device 1c in FIG. 8. The autonomous mobile device 1d may be configured to add the specific information storage unit 115 to the configurations of FIGS. 1, 6, and 7.

The specific information storage unit 115 is a storage unit for storing the managing the mark information and the sensor data of a place in which the layout of a building and an internal structure do not want to be notified the outside of by itself without being registered into the management device.

It is desirable that the autonomous mobile device 1d according to the third embodiment is not shared, but usable by only a specific user.

The management device 2 has the same configuration as that of the management device 2 in FIG. 8.

In the preprocessing device 6, preprocessing software 601 is executed. The preprocessing software 601 is a software application for masking the mark information and the sensor data of a place which does not want to be notified the outside of.

In the third embodiment, the sensor data in transmitted to the management device 2 through the preprocessing device 6.

When the autonomous mobile device 1d starts to travel, the autonomous mobile device 1d downloads, from the management device 2, the mark information and the travel path information on the published areas (areas in which the information on the publication availability of the travel path information is “published”) among the areas through which the autonomous mobile device 1d travels. The autonomous mobile device 1d copies the mark information and the travel path information on the area which is not registered in the management device 2, and is stored in the specific information storage unit 115 from the specific information storage unit 115, and uses the copied information.

Also, in studying the configuration of the sensors 102 when the autonomous mobile device 1d is introduced, and the localization precision, the preprocessing software 601 in the preprocessing device 6 is used so that the study can be conducted without allowing the outside to enter the area. The preprocessing software 601 is a software application that maintains a feature that can determine the localization precision according to the sensor data, and reduces an object recognizable feature. The preprocessing is conducted to leave a feature such as a spatial frequency of the shape in a state where a person cannot visually grasp the spatial shape for the sensor data. The preprocessing software 601 specifically removes color, and divides the shape into voxels, and thereafter mixes the voxels at random to conduct the preprocessing.

FIG. 15 is a flowchart illustrating a procedure of map data determination processing according to the third embodiment.

First, the control unit 100 of the autonomous mobile device 1d displays a screen for inquiring of the user whether to use the registered information such as the mark information the sensor data, the map data, or the image by the camera which are registered in the management device 2, as information to be determined for determining whether travel can be conducted, or not, for example, in a display screen of the preprocessing device 6. Then, the control unit 100 determines whether the registered information is used as the information to be determined, or not, on the basis of the user's input (S401).

As a result of Step S401, if the registered information is used (yes in S401), the user selects an area to be determined from a route map displayed in the input/output unit 109 (S402), and transmits the areas No. of that area to the management device 2.

Then, the control unit 200 of the management device 2 acquires the registered information of the area selected in Step S402 from the storage unit 201 (S403), and advances the processing to Step S408. The processing after Step S409 will be described later.

As a result of Step S401, if the registered information is not used (no in S401), that is, if the user wishes to study whether the travel can be conducted in an area an which the mark information or the sensor data is not registered in the management device 2, and which does not wish to be notified the outside of, the user downloads the preprocessing software to the preprocessing device 6 used by himself (S404).

Then, the autonomous mobile device 1d acquires the sensor data by traveling while taking moving pictures or successive images at given intervals by a mounted video camera or still camera, or a laser scan (that is, sensors 102), or acquiring the sensor data by the sensors 102 in the same manner as that of the normal travel, while moving on an assumed travel route (S405). In this case, the sensor data includes the images from the video camera or the still camera in addition to the sensor data in the first embodiment of the second embodiment.

Then, after the sensor data taken by the user is transmitted or input to the preprocessing device 6, the preprocessing software 601 of the preprocessing device 6 executes the preprocessing on the sensor data (S406), and uploads the preprocessed sensor data to the management device 2 (S407).

Thereafter, the user inputs photographing conditions such as the moving images, the still images, successive acquisition intervals, and photographing height to the preprocessing device 6 as the sensor data acquisition conditions (S408). Then, the user inputs the fitting conditions of the sensors 102 to the autonomous mobile device 1d scheduled to be introduced to the preprocessing device 6 (S409). Specifically, the fitting conditions are the type of the sensors 102 (camera, laser scan, etc.), the fitting height, the fitting orientation, and an unshielded angle around the sensors 102. If the registered information is transmitted to the management device 2 in Step S403, the following processing is conducted on the registered information.

The preprocessing device 6 uploads the various conditions input in Steps S408 and S409 to the management device 2. After the update processing unit 204 of the management device 2 appropriately processes the sensor data for facilitating the calculation of the localization precision, the update processing unit 204 calculates the localization precision according to the sensor data acquisition conditions and the fitting conditions (S410).

Then, the update processing unit 204 of the management device 2 transmits the calculated localization precision to the preprocessing device 6, and the preprocessing device 6 displays the transmitted localization precision on the display screen, and presents the localization precision to the user (S411).

The user confirms the present localization precision, and determines whether the localization precision is again calculated with a change of the conditions, or not (S412).

As a result of Step S412, if the localization precision is once more calculated with the change of the conditions (yes in S412), the autonomous mobile system Za returns the preprocessing to Step S408, and the user inputs the different conditions to the preprocessing device 6.

As a result of Step S412, if the localization precision is not again calculated (no in S412), the user transmits a notice indicative of the completion of processing to the management device 2 through the preprocessed device 6. The storage processing unit 205 of the management device 2 erases the updated sensor data within the management device 2 in Step S407, etc., and completes the processing.

The autonomous mobile system Za according to the third embodiment is a system having no concern about leakage of the area which does not wish to be notifies the outsides of. The management device 2 can also improve the security without leaking the calculation program of the localization precision to the external. Also, since the autonomous mobile system Za according to the third embodiment calculates the localization precision on the basis of the sensor data acquisition conditions and the fitting conditions, the user can study the optimal configuration of the sensors 102 according to the used area.

The control unit 100 in the autonomous mobile device 1, 1a, 1b, and 1c, and the respective units 103 to 114 are embodied by allowing the program stored in a ROM (read only memory) to be developed to a RAM (random access memory), and executing the program by a CPU (central processing unit).

The management device 2 is a computer such as a server, and developed by allowing a program stored in a ROM or an HD (hard disk) to the RAM, and executing the program by the CPU.

### List of Reference Signs

1, 1a, 1c, 1d, autonomous mobile device

2, management device

3, portable device (communication device)

4, dispatch device

5, remote control device

6, preprocessing device

100, control unit (autonomous mobile device)

101, storage unit

102, sensor

103, route determination unit (autonomous mobile device)

104, detection unit (autonomous mobile device)

105, update processing unit (autonomous mobile device)

106, localization unit

107, movement control unit

108, movement mechanism

109, input/output unit

110, manual control unit

111, remote control unit

112, environmental feature detection unit

113, environmental feature meaning storage unit

114, communication unit (autonomous mobile device)

115, registered information storage unit

200, control unit (management device)

201, storage unit (management device)

202, route determination unit (management device)

203, detection unit (management device)

202, update processing unit (management device)

205, storage processing unit

206, communication unit (management device)

207, general-purpose communication unit

601, preprocessing software

Z, Za, autonomous mobile system

1. An autonomous mobile method in an autonomous mobile device that autonomously moves on the basis of a localization precision which is a localization of a self-position stored in a storage unit,
wherein the autonomous mobile device calculates the localization precision on the basis of sensor data collected during travel through a sensor, and updates the localization precision stored in the storage unit.

2. The autonomous mobile method according to claim 1, wherein the localization precision is set for each of areas into which a travel path is divided.

3. The autonomous mobile method according to claim 1, wherein the autonomous mobile device travels in a different technique according to each of the location precision.

4. The autonomous mobile method according to claim 3,
wherein the autonomous mobile device manually moves in the area where the localization precision is equal to or lower than a given precision, and
wherein the autonomous mobile device autonomously moves in the area where the localization precision is larger than the given precision.

5. The autonomous mobile method according to claim 3,
wherein the autonomous mobile device moves by a remote control in the area where the localization precision is equal to or lower than a given precision, and
wherein the autonomous mobile device autonomously moves in the area where the localization precision is larger than the given precision.

6. The autonomous mobile method according to claim 1,
wherein if the mark information used for localization of the self-position, which is extracted from the sensor data, is new mark information, the autonomous mobile device stores information related to the new mark information in the storage unit.

7. The autonomous mobile method according to claim 2,
wherein the autonomous mobile device extracts an environmental feature which is information related to travel which is installed on the travel path, moves according to the environmental feature in the area where the localization precision is equal to or lower than a given precision, and autonomously moves in the area where the localization precision is larger than the given precision.

8. An autonomous mobile method in an autonomous mobile system including an autonomous device that autonomously moves the basis of a localization precision which is a localization precision of a self-position stored in a storage unit, and
a management device that stores the localization precision in the storage unit,
wherein the management device calculates the localization precision on the basis of data transmitted from a communication device provided in a general registrant, and stores the calculated localization precision in the storage unit of the management device in the storage unit of the management device, and
wherein the autonomous mobile device autonomously moves on the basis of the localization precision transmitted from the management device.

9. The autonomous mobile method according to claim 8, wherein the localization precision is set for each of areas into which a travel path is divided.

10. The autonomous mobile method according to claim 8, wherein the autonomous mobile device travels in a different technique according to each of the location precision.

11. The autonomous mobile method according to claim 10,
wherein the autonomous mobile device manually moves in the area where the localization precision is equal to or lower than a given precision, and
wherein the autonomous mobile device autonomously moves in the area where the localization precision is larger than the given precision.

12. The autonomous mobile method according to claim 10,
wherein the autonomous mobile device moves by a remote control in the area where the localization precision is equal to or lower than a given precision, and
wherein the autonomous mobile device autonomously moves in the area where the localization precision is larger than the given precision.

13. The autonomous mobile method according to claim 8,
wherein information related to a status in which the transmitted data is acquired is included in the data transmitted from the communication device, and
wherein the management device transmits a request for transmitting data in a status different from a status in which the transmitted data is acquired on the basis of the information related to the status to the communication device.

14. The autonomous mobile method according to claim 8,
wherein the autonomous mobile system further includes a dispatch device, and
wherein the dispatch device dispatches the autonomous mobile device to a given place on the basis of dispatch information transmitted from the management device.

15. The autonomous mobile method according to claim 8,
wherein the autonomous mobile system further includes a preprocessing device,
wherein the preprocessing device processes a part of sensor data acquired from the autonomous mobile device on the basis of information input through the input device and transmits the processed sensor data to the management device, and
wherein the management device calculates the localization precision on the basis of the transmitted processed sensor data.

16. The autonomous mobile method according to claim 8,
wherein the management device receives information related to the sensor in the autonomous mobile device through the input unit, and outputs the information related to the sensor together with the calculated localization precision.

17. An autonomous mobile device, comprising:
an update processing unit that calculates a localization precision which is a localization precision of a self-position on the basis of sensor data collected during travel through a sensor, and updates the localization precision stored in the storage unit; and
a control unit that conducts autonomous movement on the basis of the localization precision.

18. The autonomous mobile device according to claim 17,
wherein the localization precision is set for each of areas into which a travel path is divided.

19. The autonomous mobile device according to claim 18, wherein the control unit travels in a different technique according to each of the location precision.

20. The autonomous mobile device according to claim 17, wherein a passenger rides on the autonomous mobile device.
